(19) United States
(12) Patent Application Publication
(10) Pub. No.: US 2012/0154284 A1
(43) Pub. Date: Jun. 21, 2012

(54) KEYBOARD INPUT DEVICE

(76) Inventor: Michael Christeson, Santa Barbara, CA (US)

(21) Appl. No.: 12/973,304

(22) Filed: Dec. 20, 2010

(51) Int. Cl. G06F 3/02

(52) U.S. Cl. 345/168

(57) ABSTRACT

An improved keyboard layout for inputting characters displayed on a screen augments the sizes of individual characters relative to each other. The characters are proportionally sized to display more commonly used characters or characters more commonly used as the first character in a collection of characters, or a combination of both types of characters larger relative to less commonly used characters. The shapes of the key display and key sensitive area are sized and shaped to correspond to the end of a human finger so that an operator can chose to input with the left thumb or right thumb, left or right forefinger or both forefingers or both thumbs or using a customized orientation or shape. Less frequently used characters may be reduced in size to accommodate the enlarged characters.

### BACKGROUND

The present invention is drawn to keyboard-type input devices and systems, and more particularly to keyboards, keypads, touch screens and similar input devices, wherein individual key size as represented to a user, may be changed during data entry.

Keyboards and key pads for entering data are known in the art, as are touch screens and similar devices presenting a virtual keyboard to user. These devices are typically used to communicate letters, numbers, symbols or other indicia computing apparatus for machine operation, calculations, programming and printing. Certain key pads comprise only numbers and are typically found on telephones, or calculators and computers as adding machine type input devices.

Recently a trend toward virtual keyboards has developed. These consist of mechanical and electric keyboard representations and key pads displayed on a touch screen surface. Usually the touch screen mimics a conventional keyboard layout and responds to key strokes similar to conventional keyboard.

An increasing number of devices use touch screen technology to present keyboards or key pads to users. Touch screens are frequently found on automatic teller machines, ticket vending machines and at retail stores. In addition to presentation on large screens, touch screen technology is increasingly being applied to small, portable, and hand-held devices. Since making these devices smaller and more portable is desirable, screen space available on such devices has grown smaller.

U.S. Pat. No. 7,372,454 to Betts-LaCroix discloses a computer keyboard having keys off varying size. The size of an individual key is based on its frequency of use. In this invention, the keys are round and enlarged on a conventional computer keyboard. Frequently used letters, such as vowels, impact surrounding, less frequently used keys. This keyboard cannot be physically modified, therefore it cannot reflect both the most commonly used letters, and letters that most commonly start words. Additionally, the layout of the keyboard causes certain characters to be impacted from multiple sides, resulting is a disproportionally small key for relatively common characters. For instance the proximity of “I,” “H,” and “N” to the character “J” causes the “J” key to be less prominent than the “Q” key, used far less frequently.

U.S. Pat. No. 7,081,837 to Bollman discloses a compressed standardized keyboard wherein multiple rows of keys are reduced to a single row by assigning multiple characters to individual keys. By using a disambiguation program, words can be predicated by certain character combinations. While this invention saves space by reducing the size of the overall keyboard, it fails to address speed and accuracy since more commonly used letters are not highlighted over less commonly used letters.

U.S. Pat. No. 6,765,556 to Kandogan et al. discloses a character text entry method using a two-key input system. In this reference, two keys are used to select individual characters. The two keys are located in the same row, the first key comprising the desired character, among others, and the second key denoting which, among the various characters on the first key is to be selected. This invention fails to anticipate the applicant's invention in several respects. It fails to enable a user to type with one key stroke per character, and moreover cannot to highlight particular characters based on their frequency of use.

While the references attempt to either present a compressed keyboard, keyboards capable of using key combinations representing multiple characters, or variable sized keys, they fail to present an invention permitting an entire keyboard layout display while enlarging statistically relevant letters based on frequency of use. Therefore it is an object of the present invention to present a virtual touch screen keyboard. A further object of the invention is to present a virtual touch screen keyboard representing a conventional “querty” format keyboard. Yet another object of the invention is to present a virtual “querty” format keyboard which uses letter frequency algorithms to present keys of varying size, thereby presenting keys more statistically likely to be used more prominently. These and other objects are further explained in the appended summary, description and claims.

### SUMMARY

It is an object of the invention to provide an improved input means which shapes the key display and sensitive area to conform to the shape and orientation of the end of the human finger. In this manner, the operator can chose to input with the left thumb or right thumb, left or right forefinger or both forefingers or both thumbs or using a customized orientation or shape.

By using the spacing between keys and rows of keys and around the edges of a displayed keyboard or key pad, the largest possible selected keys may be displayed for a given screen size to increase input accuracy. By enlarging, highlighting or illuminating the displayed keys for more frequently used letters, typing with greater speed and accuracy can be achieved.

### BRIEF DESCRIPTION OF THE FIGURES

FIG. 1 shows an example of a “QWERTY” keyboard according to the present invention in portrait view orientation.

FIG. 2 shows an example of a “QWERTY” keyboard according to the present invention in landscape view orientation.

FIG. 3 shows an example of a left forefinger tips touch prints as displayed on a cell phone sized number keypad.

FIG. 4 shows an example of a right thumbprint tips touch print as displayed on a cell phone sized number keypad.

FIG. 5 shows the relative frequencies of use for the first letters of words in the English language.

FIG. 6 shows the relative frequency of use of letters in the English language.

FIG. 7 shows a keyboard enhanced by increasing the size of an individual letter in proportion to its frequency as the first letter in a word.

FIG. 8 shows a keyboard as shown in FIG. 2 enhanced by sizing individual letters in proportion to the frequency used in a word.

FIG. 9 shows a keyboard improved by sizing the letters by the higher of their use in the English language or their frequency as the first letter of words in the English language.

### DESCRIPTION

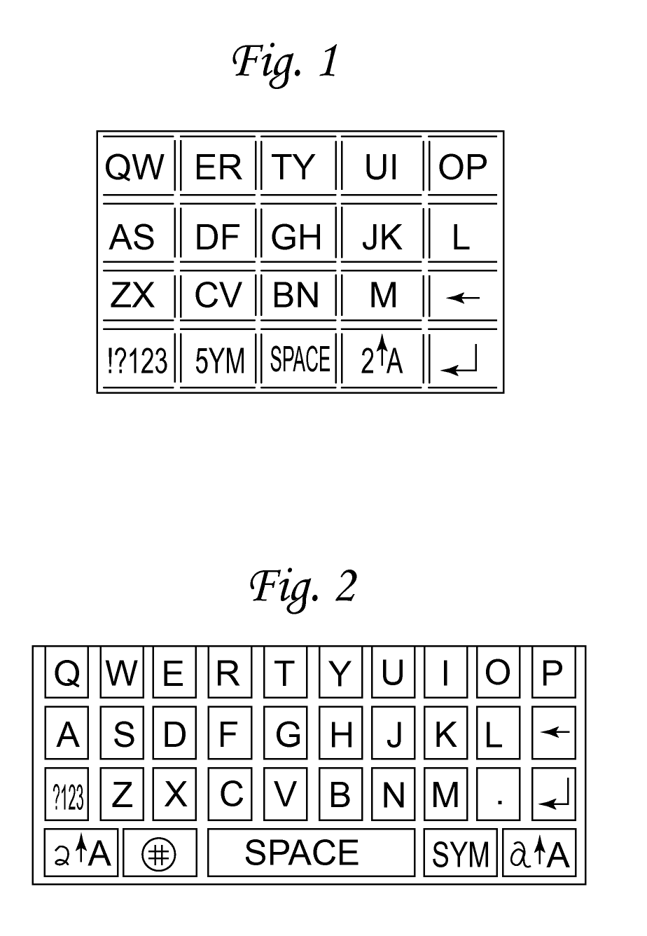

Referring to FIG. 1, an example of a keyboard in “QWERTY” format is shown. In this view, the keyboard is shown in portrait view. That is, the height of the screen is greater than the screen's width. In this view, because of the compressed space into which the keyboard must fit, multiple characters have been assigned to individual keys. In this orientation, as users input characters, the keys corresponding to multiple characters will be highlighted according to their frequency of use.

Referring to FIG. 2, an example of a keyboard in “QUERTY” format is shown. In this view, the keyboard is shown in landscape view. That is, the width of the screen is greater than the screen's height. In this view, since the space into which the keyboard must fit is larger than in portrait view, individual characters are assigned to individual keys. In this orientation, as users input characters, keys corresponding to individual characters will be highlighted according to particular characters their frequency of use.

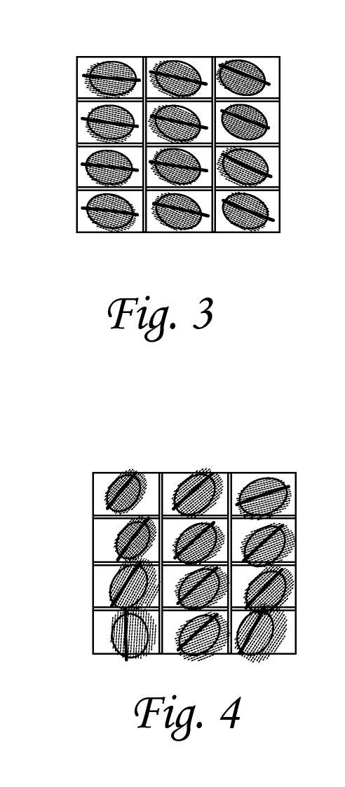

Referring to FIG. 3, an example of left forefinger touch prints on a keyboard is shown. The orientation of the forefinger print 10 to the touch screen 20 results in a touch print pattern substantially oblong along a horizontal axis. Referring to FIG. 4, an example of right thumb touch prints on a keyboard is shown. The orientation of the thumb print 30 to the touch screen 20 results in a touch print patter substantially oblong along a slanted axis. In either instance, the touch print of a finger or thumb results in a restricted area in which separate keys may be presented to a user.

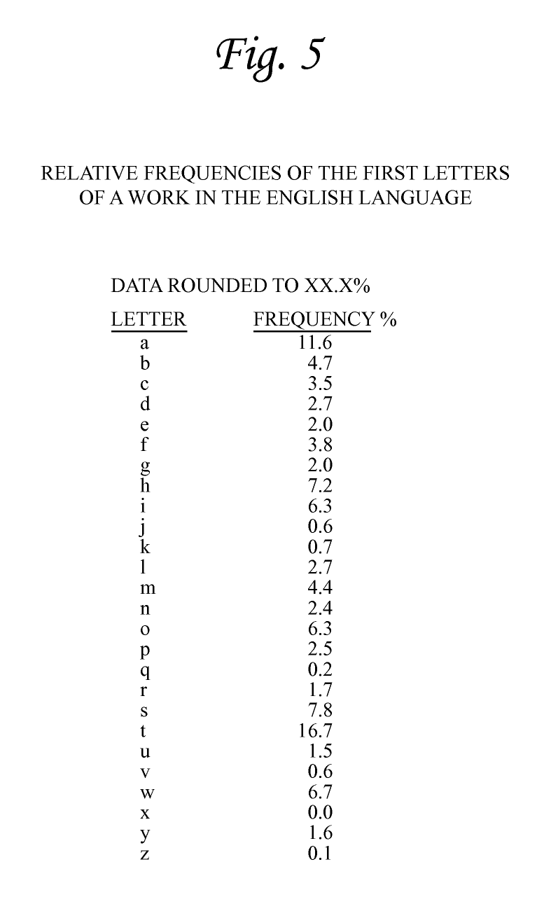

Referring to FIG. 5, a table is provided showing the relative frequencies of use for the first letters of English Language words. Using this data, letters that more frequently begin a word (such as “T” and “A”) may be presented in a highlighted form on the keyboard once the keyboard is displayed, but prior to a user beginning any keystrokes.

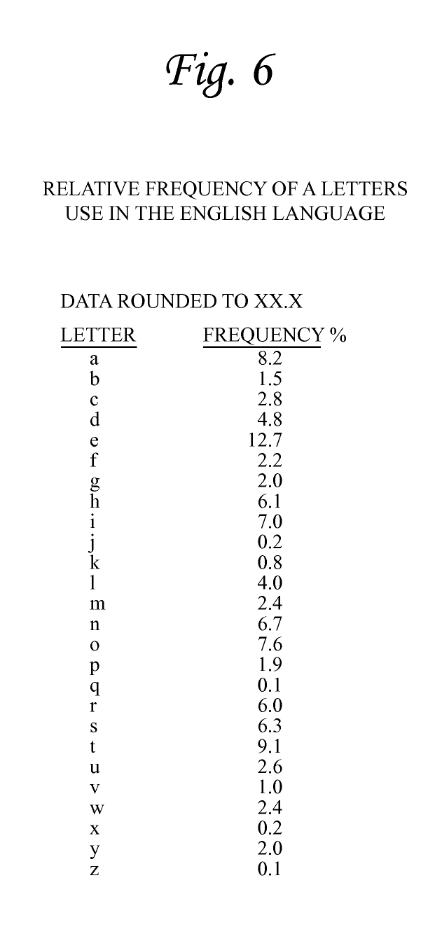

Referring to FIG. 6, a table is provided showing the relative frequencies of use for letters in the English language, regardless of where they occur in a word. Using this data, letters that more frequently occur in a word (such as “E” and “I”) may be presented in a highlighted form on the keyboard after a user begins typing a word. By combining the tables in FIGS. 5 and 6 with the appropriate algorithm, the present invention can highlight the most likely letters to be used by a keyboard typist.

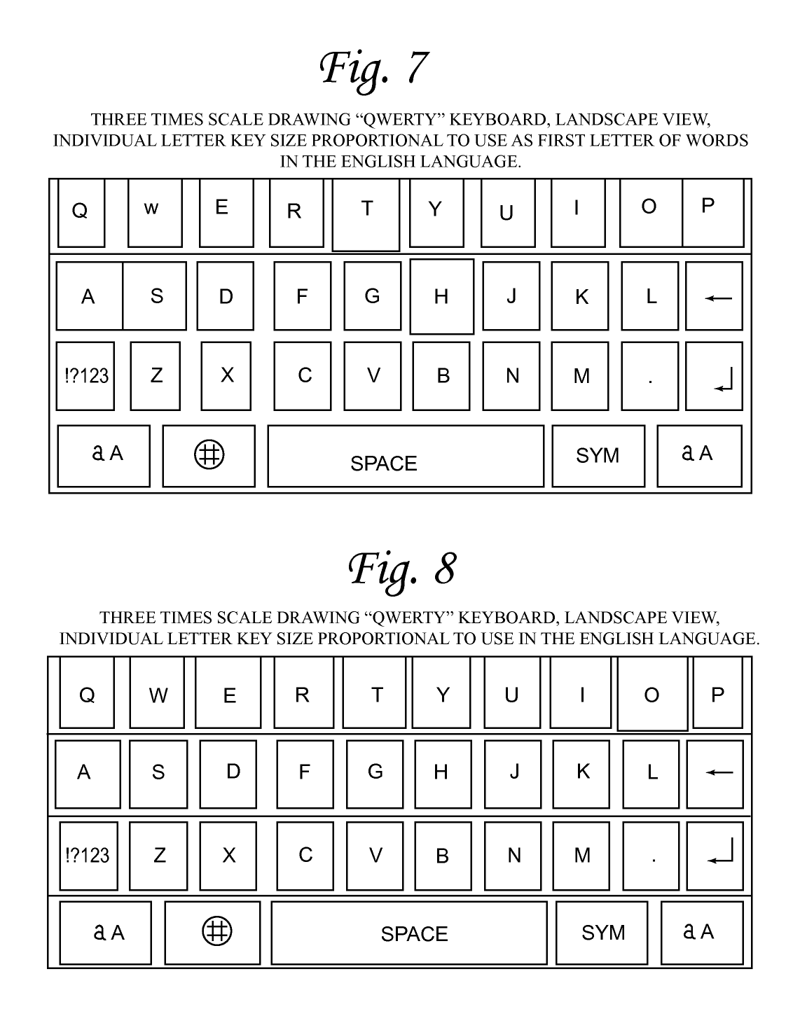

Referring to FIG. 7, a “QWERTY” format keyboard is shown in landscape view. In this layout, individual key sizes have been augmented to present the most commonly used letters that begin words proportionally larger than those letters which do not commonly begin words. Therefore the letters “T” 50, “A” 52, “S” 54, and “H” 56 are displayed largest since they are the most common letters that begin words, while “Q” 58, “Z” 60, and “X” 62 are displayed smallest since they are the least common letters that begin words.

Referring to FIG. 8, a “QWERTY” format keyboard is shown in landscape view. In this layout, individual key sizes have been augmented to present the most commonly used letters, regardless of position in a word, so that more commonly used letters are proportionally larger than less commonly used letters. Therefore the letters “E” 70, “T” 72, “A” 74, and “O” 76 are displayed largest since they occur in words more often than any other letters, while “Q” 78, “X” 80, and “Z” 82 are displayed smallest since they are the least common letters in words.

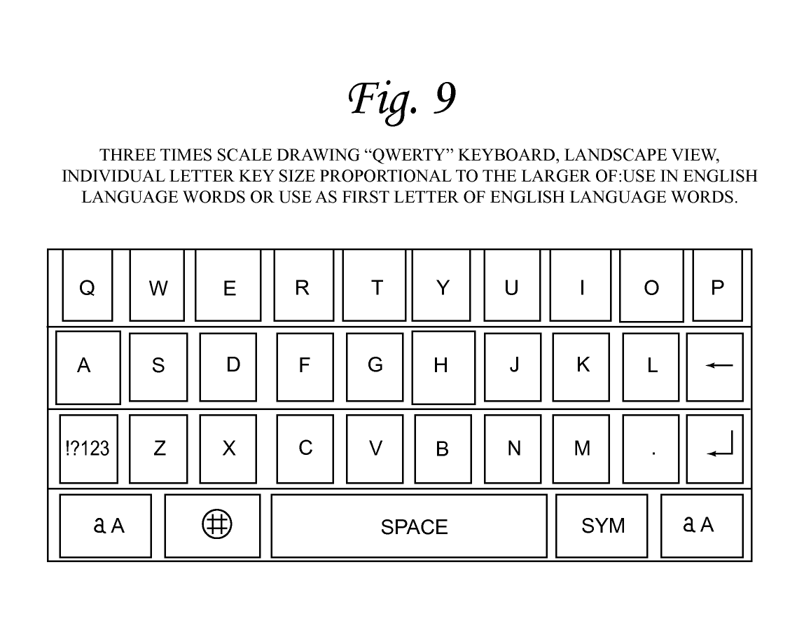

As shown in FIG. 9, it should be noted that in addition to instances where the most commonly used first letters are highlighted as shown in FIG. 7, and instances where the most commonly used letters are highlighted as shown in FIG. 8, the invention may comprise a combination, wherein both the most commonly used first letters and the most commonly used letters overall are highlighted.

It is also anticipated that the system may alter the algorithm used in real time, so that a user is initially displayed a keyboard with the common first letters highlighted. Then, after the first letter of a word is selected, a second algorithm, showing the most commonly used letters highlighted, is employed to highlight anticipated subsequent letters.

Although the present invention has been described in considerable detail with reference to certain preferred versions thereof, other versions are possible. For instance the escutcheon and base assembly may be used for outdoor fixtures, and other areas where a tool-less quick disassembly is desirable. Therefore, the spirit and scope of the appended claims should not be limited to the description of the preferred versions contained herein.

Any element in a claim that does not explicitly state “means for” performing a specified function, or “step for” performing a specific function, is not to be interpreted as a “means” or “step” clause as specified in 35 U.S.C. §112, ¶6. In particular, the use of “step of” in the claims herein is not intended to invoke the provisions of 35 U.S.C. §112, ¶6.

What is claimed is:

1. An improved keyboard for inputting characters and symbols comprising;
a landscape oriented on-screen keyboard layout having keys of various sizes;
said key sizes of individual characters corresponding to the commonality of those characters; and
wherein characters more frequently used as the first letter of a word are enlarged relative to other characters.

2. The keyboard for inputting characters of claim 1 wherein the largest letters displayed are chosen from the list of T, A, S, and H.

3. The keyboard for inputting characters of claim 1 wherein infrequently used characters are reduced in size to accommodate the increased size of characters used to begin words.

4. The keyboard for inputting characters of claim 1 wherein the letters Q, Z, and X are reduced in size.

5. The keyboard for imputing characters of claim 1 wherein the characters are chosen from letters of the Roman-Latin alphabet.

6. An improved keyboard for inputting characters and symbols comprising;
a landscape oriented on-screen keyboard layout having keys of various sizes;
said key sizes of individual characters corresponding to the commonality of those characters; and
wherein characters used more frequently are enlarged relative to other characters.

7. The keyboard for inputting characters of claim 6 wherein the largest letters displayed are chosen from the list of E, T, A, and O.

8. The keyboard for inputting characters of claim 6 wherein infrequently used characters are reduced in size to accommodate the increased size of characters used to begin words.

9. The keyboard for inputting characters of claim 6 wherein the letters Q, Z, and X are reduced in size.

10. The keyboard for imputing characters of claim 1 wherein the characters are chosen from letters of the Roman-Latin alphabet.

11. An improved keyboard for inputting characters and symbols comprising;
a landscape oriented on-screen keyboard layout having keys of various sizes;
said key sizes of individual characters corresponding to the commonality of those characters in a predetermined language; and
wherein those characters more frequently used as the first character in a word and those characters more frequently used in any position in a word are enlarged relative to the other characters.

12. The keyboard for inputting characters of claim 11 wherein the largest letters displayed are chosen from the list of E, T, A, S, H, and O.

13. The keyboard for inputting characters of claim 11 wherein infrequently used characters are reduced in size to accommodate the increased size of characters used to begin words.

14. The keyboard for inputting characters of claim 11 wherein the letters Q, Z, and X are reduced in size.

15. The keyboard for imputing characters of claim 11 wherein the characters are chosen from letters of the Roman-Latin alphabet.
